(19) United States
(12) Patent Application Publication
(10) Pub. No.: US 2024/0326068 A1
(43) Pub. Date: Oct. 3, 2024

(54) CENTRIFUGE AND METHOD FOR OPERATING SAID CENTRIFUGE

(71) Applicant: GEA WESTFALIA SEPARATOR GROUP GMBH, Oelde (DE)

(72) Inventors: Tim HUNDERTMARK, Gütersloh (DE); Björn STRÖFER, Beckum (DE); Wolf-Dietrich HERBERG, Witten (DE)

(21) Appl. No.: 18/682,173

(22) PCT Filed: Jul. 26, 2022
(86) PCT No.: PCT/EP2022/070874

§ 371 Date: Feb. 8, 2024

(30) Foreign Application Priority Data
Aug. 9, 2021 (DE) 10 2021 120 611.1

(51) Int. Cl. B04B 1/08; B04B 11/08

(52) U.S. Cl. CPC B04B 1/08; B04B 11/082

(57) ABSTRACT

A centrifuge includes a rotatably mounted drum, a drive motor, a drum shell made of metal and a vertical axis of rotation. The drum has a feed tube, a paring chamber with a paring disk for leading away clarified or separated liquid, and a solids discharge. The drum has, above the paring chamber, at least two sealing chambers, which lie one axially above the other and which each have a sealing disk protruding into the respective sealing chamber. The centrifuge includes at least one supply channel for supplying a sealing medium to one of the sealing chambers or includes, for each sealing chamber, at least one supply channel for supplying a sealing medium to the respective sealing chamber.

### BACKGROUND AND SUMMARY OF THE INVENTION

Exemplary embodiments of the present invention relate to a centrifuge and to a method for operating the centrifuge.

Centrifuges-especially separators—that process products that change their product properties on contact with oxygen must be sealed against an oxygen-containing atmosphere. Sealing also allows the gases dissolved in the product to be completely retained in the product, as is desirable in the centrifugal clarification of beer, for example.

In such centrifuges, one or more liquid phases are often drawn off through an outlet in which a so-called stationary gripper is arranged. The gripper—also known as a paring disk-works according to the principle of a centripetal pump.

In the drum of such a centrifuge, there is a so-called sealing disk in the head, which is surrounded by a rotating chamber. The chamber is filled with a sealing liquid into which the sealing disk is immersed, forming a siphon-like seal. This seals the gripper and drum chamber so that there is no contact with the surrounding atmosphere. Such a construction is known from DE 196 31 226 A1. Nevertheless, a certain amount of oxygen absorption is still observed with this simple seal, as some of the oxygen diffuses through the sealing liquid. This effect also occurs with degassed water. For this reason, current centrifuges require additional displacement of the oxygen atmosphere above the rotating sealing or hermetic chamber by inerting gases such as CO₂.

Furthermore, so-called fully hermetic centrifuges are known in which the rotor is sealed against the atmosphere with shaft and mechanical seals. In addition, the area of the sealing points is pressurized so that no oxygen can penetrate from outside, as described, for example, in U.S. Pat. No. 3,126,338. These sealing systems are quite expensive, maintenance-intensive, and sensitive, e.g., to imbalances and discharge pulses. A loss of the seal leads to the undesired entry of oxygen into the rotating system of the centrifuge.

Based on the prior art described above, exemplary embodiments of the present invention are directed to a centrifuge and a method for operating this centrifuge, which has an improved sealing of the product in the drum with respect to the oxygen-rich environment.

A centrifuge is provided for separating or clarifying a flowable product or a flowable suspension into at least two phases in a centrifugal field in continuous operation, wherein the centrifuge has a rotatably mounted drum drivable by means of a drive motor and having a drum shell made of metal with a vertical axis of rotation, wherein the drum further comprises a feed pipe and at least one gripper chamber with a gripper for discharging clarified or separated liquid and preferably a solids discharge, and wherein the drum comprises at least two axially superimposed sealing chambers above the gripper chamber, each having a sealing disk projecting into the respective sealing chamber, and wherein at least one feed channel is provided for feeding a sealing medium into one of the sealing chambers or at least one feed channel is provided for feeding a sealing medium into the respective sealing chamber.

This creates a very good quasi double “hydrohermetically” sealed drum.

The centrifuge according to the invention is more robust than a centrifuge with a fully hermetic design, as there are no mechanical seals that are susceptible to wear.

According to a particularly preferred variant, a line is provided, in particular, for feeding a gas into an annular space around an intermediate annular wall extending radially inwards from the drum shell between the two sealing chambers or for evacuating a gas from the annular space.

According to one variant, it may then further be preferably provided that a discharge line is provided for discharging gas from the annular space.

Preferably, a sealing gas that is heavier than air is introduced into an annular space between the two sealing disks. During operation of the centrifuge, the sealing gas, which is preferably heavier than air, is then located in the annular space between the two sealing disks.

This creates a centrifuge having a particularly improved barrier or sealing between the product in the drum and the generally oxygen-rich environment (in the hood chamber). The sealing gas volume held in the annular space between the sealing chambers in particular contributes to this further optimized sealing.

A centrifuge according to the invention is particularly suitable for all centrifugal processes in which the exclusion of oxygen to the greatest possible extent is advantageous in order to avoid undesirable oxidation processes.

This is the case when processing beverages, e.g., for fruit juices or beer. For example, vitamin C from citrus fruits or other fruit and vegetables reacts with oxygen. Other natural products are also oxidized, changing their color and taste.

In a particularly preferred design of the invention, it may be provided that the first sealing chamber is delimited radially below by a lower annular wall from a gripper chamber into which a gripper is inserted. This enables hydrohermetization of the drum at a useful position. Furthermore, a wall of the gripper chamber can also be used as a wall for the sealing chamber to save installation space.

In a further particularly preferred design of the invention, it may be provided that the first sealing chamber is separated from the second sealing chamber by an intermediate wall. This results in a space-saving arrangement of the second sealing chamber radially above the first sealing chamber. Furthermore, in another particularly preferred embodiment option of the invention, it may be provided that the centrifuge has at least one feed channel for feeding a sealing liquid into the respective sealing chamber. As a result, if two channels are present, each sealing chamber can be filled separately from the other. This makes it possible to fill one or both sealing chambers without pressure or with a back pressure. This allows the sealing chamber(s) to be filled with sealing liquid flexibly according to the current hermetization requirements.

Likewise, in a further particularly preferred embodiment option of the invention, it may be provided that a radius R_{M1} at the mouth of the respective feed channel in the sealing chamber is smaller than the radius R_{AZ} of an outer edge of the intermediate wall. This results in a structurally simple and easily producible pressureless filling of the sealing chambers with sealing liquid, which is only dependent on the geometry.

Furthermore, in a further particularly preferred design of the invention, it may be provided that a radius R_{M2} at the mouth of the respective feed channel in the respective sealing chamber is larger than the radius R_{AZ} of the outer edge of the intermediate wall. This results in a structurally simple and easily producible ability to fill the sealing chambers with sealing liquid with a counterpressure, as this is only dependent on the geometry.

In a further particularly preferred design of the invention, it may be provided that the sealing gas flows through a line into the space between the two sealing chambers and flows out of the space through an outlet for the sealing gas. This results in a structurally simple exchange of the sealing gas.

Furthermore, it may be provided in another particularly preferred embodiment option of the invention that a gas sensor, in particular a CO₂ sensor, can be provided on the line and/or on the outlet of the sealing gas. In this way, the prerequisite for a type of filling level regulation for the sealing gas in the space is created in a structurally simple and thus advantageous manner.

Exemplary embodiments of the present invention are also directed to a method for operating the centrifuge according to the invention.

The method is characterized in that the space between the two sealing chambers is continuously flushed with an inert sealing gas during operation of the centrifuge, so that any air or oxygen that may have penetrated from the space under the hood through the sealing liquid in the second sealing chamber is flushed out.

The continuous exchange of sealing gas from the chamber ensures that the drum is hermetically sealed.

This significantly reduces unwanted oxygen absorption into the product.

The centrifuge according to the invention is more robust than a centrifuge with a fully hermetic design, as there are no mechanical seals that are susceptible to wear. The need for sealing gas is significantly lower compared to inerting the entire centrifuge or inerting a space above the sealing chambers. The power requirement for driving the centrifuge is also reduced, as the entire rotor no longer rotates in an inert gas atmosphere with a density greater than air. The risk of CO₂ escaping and contaminating the space outside the centrifuge is also reduced.

Another area of application is oxygen-sensitive reactions, which can occur in chemical synthesis, for example of pharmaceutical products. Typically, the application involves a variety of reactions under inert gas. Argon in particular can be used here instead of CO₂ due to its chemical inertness.

The invention also provides advantageous methods for operating the centrifuges according to the invention, in particular separators.

Thus, it provides a particularly simple method for operating a centrifuge described above, comprising the following steps:
i) Providing the centrifuge and rotating the drum,
ii) Supplying a suspension to be processed and separation of the suspension into at least two phases,
iii) Filling one of the two sealing chambers with sealing liquid via the feed channel leading into it without additional counterpressure, so that the outlet opening from the feed channel for supplying the sealing liquid is not immersed in the sealing liquid in this sealing chamber until the sealing disk in this sealing chamber is immersed in the sealing liquid and overflows into the other sealing chamber, and continuous filling until the other sealing chamber fills so that its sealing disk is immersed in the sealing liquid.

This method is simple and leads to an advantageous filling of both sealing chambers with the sealing liquid.

Steps ii) and iii) can be carried out here and in the other variants one after the other, but also simultaneously.

Instead of two sealing chambers, and in other variants, more than two sealing chambers can be provided, which lie directly axially one above the other.

According to an aspect, on the other hand, a method is provided for operating a centrifuge described above, comprising the following steps:
i) Providing the centrifuge and rotating the drum,
ii) Supplying a suspension to be processed and separation of the suspension into at least two phases,
iii) Filling the two sealing chambers with a supply pressure until the two sealing disks are immersed in the sealing liquid.

This method is also simple and leads to an advantageous filling of both sealing chambers with the sealing liquid.

Steps ii) and iii) can be carried out here and in the other variants one after the other, but also simultaneously.

Instead of two sealing chambers, and in other variants, more than two sealing chambers can be provided, which lie directly axially one above the other.

The following further step iv) can follow:
Pressurizing the annular space, which is axially limited by the two sealing disks and in which the intermediate annular wall is located, with a gas, in particular a sealing gas, during centrifugal operation of the centrifuge, or
Evacuating the annular space during centrifugal operation of the centrifuge.

In this way, the effect of the two axially arranged sealing chambers and the sealing of the gripper chamber against the ingress of ambient air is significantly optimized.

Finally, the invention also provides the use of a centrifuge configured as described above in beverage processing and/or in the chemical synthesis of a compound, in particular a pharmaceutical product.

### BRIEF DESCRIPTION OF THE DRAWING FIGURES

Further advantages, features and details of the invention can be seen from the following description, in which an exemplary embodiment of the invention is explained in more detail with reference to the drawings. The person skilled in the art will also usefully consider the features disclosed in combination in the drawing, the description and the subclaims individually and combine them to form useful further combinations, wherein:

FIG. 1: shows a schematic representation in full section of a centrifuge designed as a separator;

FIG. 2: shows a detailed representation of the head area of the drum of the centrifuge according to a first design configuration with two sealing chambers, in which the sealing chambers are filled according to a first alternative method;

FIG. 3: shows a detailed view of the head area of the drum of the centrifuge according to the first design configuration with two sealing chambers, in which the sealing chambers are filled according to a second alternative method;

FIGS. 4 to 6: each show a detailed view of the head area of the drum of the centrifuge according to various design configurations, in which the sealing chambers are filled according to an alternative method.

### DETAILED DESCRIPTION

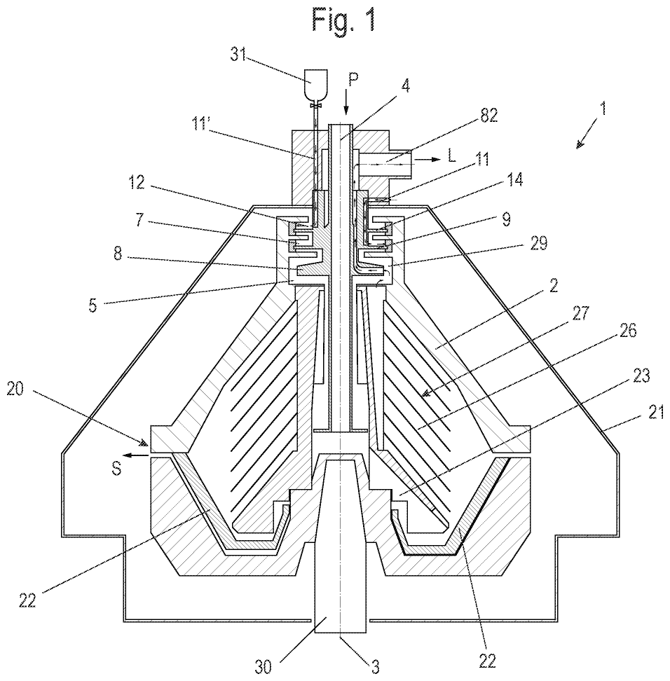

FIG. 1 shows a centrifuge 1 designed as a separator for separating or clarifying a flowable product or a flowable suspension P into at least two phases L, S in a centrifugal field.

The centrifuge 1 has a rotating system with a drum 2 arranged rotatably on or on a rotatable spindle 30. The spindle 30 is preferably aligned vertically and can be driven directly or indirectly—e.g., via a drive belt. The drive is preferably realized by a drive motor, in particular an electric motor, of the centrifuge (not shown).

The drum 2, in particular the drum shell, can be made of a wide variety of materials. In the context of this document, the drum 2 or the drum shell is made of metal. The drum 2 can have a vertical axis of rotation 3. The drum 2 can be designed for continuous operation. The drum 2 can be essentially of single or double conical design.

The drum 2 initially has an inlet. This can have a centrally arranged feed pipe 4, which is stationary during operation of the centrifuge 1 and through which a product P can be fed into a distributor 23 of the drum 2 and from there into the separation chamber 26. The feed pipe 4 forms part of a shaft arrangement 41 that does not rotate during operation and which extends axially into the drum 2 from a location outside the drum, but does not rotate with the latter during operation. The shaft arrangement 41 and the drum 2 are therefore radially spaced apart. The inlet can also be designed in a different way. For example, the feed pipe 4 can be designed to rotate and/or be provided at the lower end of the drum 2 (not shown).

The product P to be processed, which is fed into the drum 2 through the feed pipe 4, exits the end of the feed pipe 4 and flows through a distributor 23 that rotates with the drum 1 and then enters the actual separation chamber 26. There it is separated into at least two phases-in this case a liquid phase L and a solid phase S. In the exemplary embodiment shown in FIG. 1, the starting product is clarified, i.e., the solid phase S is separated from the product P to be processed. For this purpose, the product P to be processed enters a separating plate stack 27 in the separating chamber 26.

In the left part of FIG. 1, the piston slide 22 is shown schematically in the closed position, in which it closes the discharge nozzles 20, and in the right part in a position in which the discharge nozzles 20 are open.

The drum 2 then has a solids discharge. This can have a piston slide 22 and a plurality of discharge openings 20, which are provided as a discontinuous outlet for the solids phase S. The drum 2 has at least one gripper chamber 5 that rotates with the drum 2 during operation of the centrifuge 1 and in which a gripper 8—also referred to as a paring disk in technical terminology—is inserted while the centrifuge 1 is in operation.

The gripper 8 works according to the principle of a centripetal pump. Accordingly, one liquid phase L is discharged from the drum 2 through one or more discharge channels 81 within the gripper 8 through the discharge pipe 82. Two grippers 8 and gripper chambers 5 arranged axially one above the other could also be provided in order to discharge two liquid phases. The drum 2 would then preferably be designed for separation into two liquid phases and one solid phase (not shown).

Above the gripper chamber 5, a first sealing chamber 7 is provided that runs around the drum 2. This serves to form a first hydrohermetic seal.

In the first sealing chamber 7, which rotates with the drum 2 during operation of the centrifuge 1, a first sealing disk 9 is arranged for this purpose, which can be firmly connected directly or via further elements to the shaft arrangement 41 and therefore does not rotate during operation of the centrifuge 1. It extends radially outwards into the sealing chamber 7 perpendicular to the axis of rotation 3.

The first sealing chamber 7 is formed perpendicular to the axis of rotation 3. The drum head 29 can be completely cylindrical or have an upper section in which the outer drum wall or the drum shell is essentially cylindrical.

A second sealing chamber 12 is arranged axially above the first sealing chamber 7. A second sealing disk 14 is inserted into the second sealing chamber 12, which is also firmly connected to the shaft arrangement 41 and therefore also does not rotate during operation of the centrifuge 1. This sealing disk 14 also extends radially from the inside to the outside. They are formed perpendicular to the axis of rotation 3.

The two sealing chambers 7, 12 are each axially bounded by annular walls 16, 17, 18, which extend radially inwards perpendicular to the axis of rotation 3 starting from the inner circumference of the drum shell of the drum head 29. They are radially spaced from the inner non-rotating shaft arrangement 41 or shaft assembly with the feed pipe 4 and the at least one axial gripper channel 81 from the paring disk or the gripper 8 of the drum 2. The sealing chambers 7, 12 are each bounded radially outwards by the drum shell.

The sealing chambers 7, 12 can be pressurized with a liquid sealing medium 32—in particular water or the product P to be processed itself. A liquid ring/cylinder is then formed radially on the outside of the respective sealing chamber 7, 12. This is dimensioned so that the sealing disks 9, 14 are immersed radially in the sealing medium 32 during operation of the centrifuge 1, so that a double hydrohermetic seal is formed.

For this purpose, at least one feed channel 11 can be provided or several feed channels 11, 11′ can be provided. The respective feed channel 11, 11′ preferably extends from a location outside the drum 2 through the shaft arrangement 41 into the respective sealing chamber 7 and/or 12. The sealing medium 32 can, for example, flow into the feed channels 11, 11′ from a reservoir 31 located outside the centrifuge.

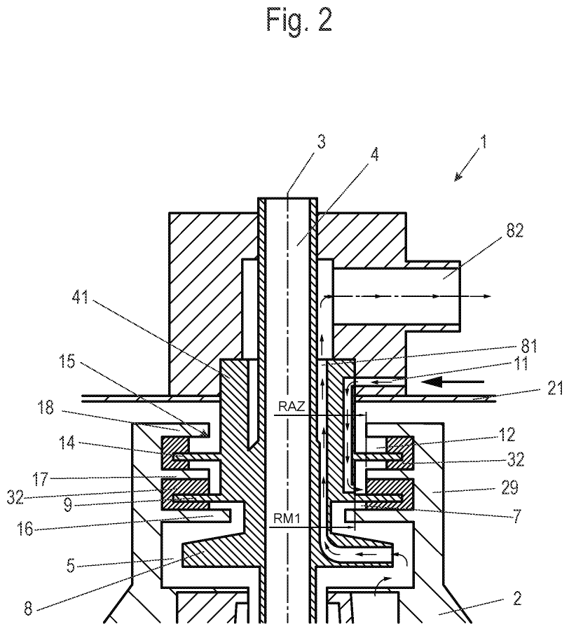

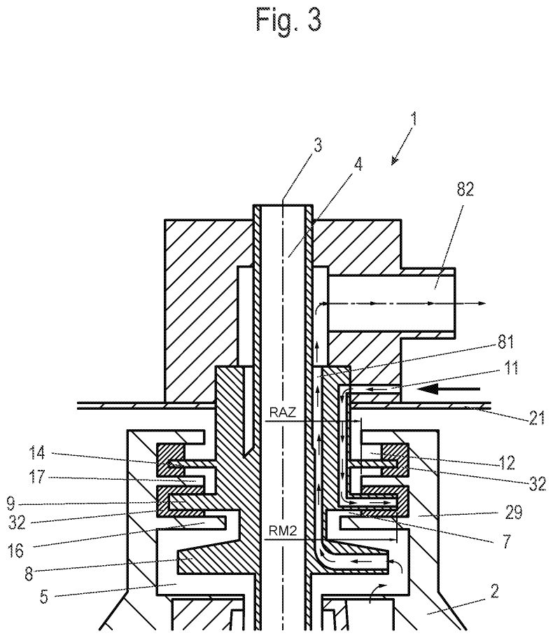

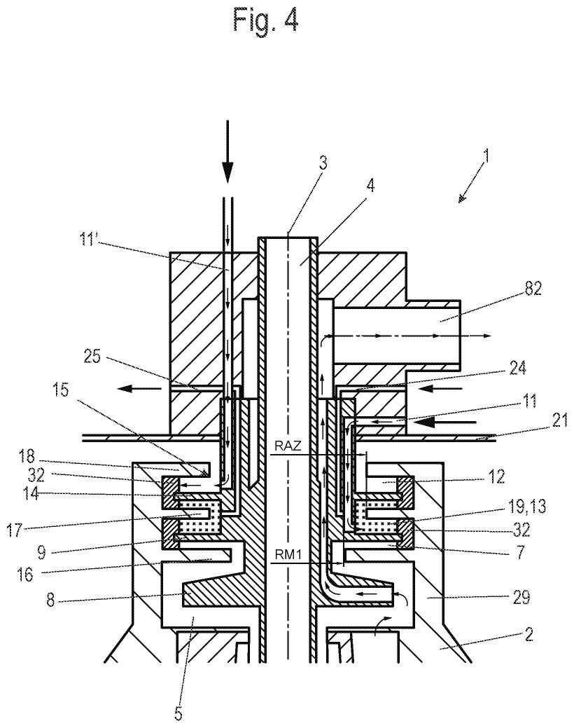

For example, only one feed channel 11 can extend into the lower sealing chamber 7 (FIG. 2 or 3). However, it may also be provided that one feed channel 11, 11′ extends in each case into each of the sealing chambers 7, 12 (FIG. 4, 5 or 6).

During operation, the liquid sealing medium 32 is fed into the sealing chambers 7, 12 through the respective feed channel 11, 11′, which collects as a result of centrifugal forces occurring during the rotation of the drum on the outside in the two sealing chambers 7 and 12 and forms a liquid ring there.

If the sealing disks 9 and 14 are immersed radially from the inside into the respective liquid ring in the respective sealing chamber 7, 12, a fluid seal is formed between the gripper chamber 5 and the interior of the hood or the surrounding space of the drum 2 in the hood 21 by the interaction of the sealing disk 9, 14 and the liquid ring of the respective sealing chamber 7, 12.

This is achieved particularly advantageously with the various design variants and/or process engineering alternatives.

For example, water or the product to be processed can be used as the sealing medium 32. Other sealing media are also conceivable.

The first sealing chamber 7 is delimited radially downwards by a lower annular wall 16 from the gripper chamber 5, into which the gripper 8 is inserted. Furthermore, the first sealing chamber 7 is separated from the second sealing chamber 12 by an intermediate annular wall 17. The second sealing chamber 12 has an annular wall 18 radially at the top, which delimits the upper side and has an overflow edge 15 radially on the inside, at which liquid can escape from the rotating system into the hood chamber 21.

FIG. 2 shows a detailed representation of the drum head 29 of the drum 2 of the centrifuge 1 according to a first design configuration, in which a supply of sealing liquid takes place according to a first alternative.

According to this design, a feed channel 11 extends from a region outside the drum 2 through the axially extending and non-rotating inner shaft arrangement 41 into the area of the lower sealing chamber 7. The feed channel 11 ends here axially above the lower sealing disk 9 in the first lower sealing chamber 7. It has a radially aligned outlet opening here. This is located radially further inwards than the outer edge of the first sealing disk 9.

The second upper sealing chamber 12, on the other hand, does not have its own feed channel or—if present—this is not used.

In this design, according to the first process engineering alternative, the upper sealing chamber 12 is therefore filled with the sealing medium 32 via the lower sealing chamber 7, namely via a feed channel opening into the lower sealing chamber 7.

A control unit is provided to control the operation of the separator. This can also be used to control or regulate the filling of the sealing chambers 7, 12 during operation.

This is carried out as follows:

First, a centrifuge 1—in particular as shown in FIG. 1 with the drum head 29—in particular as shown in FIG. 2—is provided. Then the drum 2 is set in rotation by a drive (not shown here).

The first lower first sealing chamber 7 is then filled with sealing liquid via the feed channel 11. The outlet opening from the feed channel 11 for supplying the sealing liquid does not dip into the sealing liquid in the first sealing chamber 7—in this case due to the selected arrangement in FIG. 2—and is added without counterpressure.

This is possible because the radius R_{M1} at the mouth of the feed channel 11 in the sealing chamber 7 is smaller than the radius R_{AZ} of a radial inner edge of the intermediate annular wall 17.

After an overflow of the first sealing chamber 7, the second upper sealing chamber 12 fills, as the lower annular wall 16 between the first sealing chamber 7 and the gripper chamber 5 extends further radially inwards than the intermediate annular wall 17 between the two sealing chambers 7, 12. If the upper second sealing chamber 12 overflows, the sealing liquid passes via the overflow edge 15 into the hood space inside the hood 21.

Alternatively, the upper sealing chamber 12 can also be filled, which then overflows into the lower sealing chamber 7. The feed channel 11′ then flows into the upper sealing chamber 12.

Both sealing chambers 7, 12 can also each have a feed channel 11. In this case, one feed channel is not used for filling according to one of the two methods described above.

FIG. 3 shows a detailed representation of the drum head 29 of the drum 2 of the centrifuge 1 according to the first design configuration of FIG. 2, in which a supply of sealing liquid takes place according to a second process engineering alternative.

First, a centrifuge with a drum 2—for example as shown in FIG. 1—with the drum head 29 as shown in FIG. 3 is provided. Then the drum 2 is set in rotation by a drive (not shown here).

The first sealing chamber 7 is in turn filled with sealing liquid through the feed channel 11. The feed channel 11 for supplying the sealing liquid is immersed in the sealing liquid in the first sealing chamber 7 and is added with the required supply pressure.

This is possible because the radius R_{M2} at the mouth of the feed channel 11 in the sealing chamber 7 is larger than the radius R_{AZ} of an inner radius of the intermediate wall 17.

The filling level of the sealing liquid can be adjusted via the inlet pressure.

This can preferably be carried out automatically in a control unit (not shown here).

After an overflow of the first sealing chamber 7, the second sealing chamber 12 fills up. If the second sealing chamber 12 overflows, the sealing liquid enters the hood space.

In this way, an excellent seal between the hood space and the gripper chamber 5 is achieved by means of a multiple sealing chamber arrangement—in this case a double sealing chamber arrangement with two axially adjacent sealing chambers 7 and 12.

It is still possible that a very low oxygen uptake of the product P and/or the discharged liquid phase L can occur if some oxygen diffuses through the sealing liquid.

In a centrifuge with a hermetized outlet for a liquid phase, the oxygen atmosphere can therefore be additionally displaced by inert gases such as CO₂.

FIG. 4 shows a detailed view of the drum head 29 of the drum 2 of the centrifuge 1 according to a second design, in which a supply of sealing liquid takes place according to the first alternative.

Apart from the drum head 29, the drum 2 can be constructed in the same way as FIG. 1, for example.

Two axially superimposed sealing chambers 7, 12 are also provided.

The arrangement of the sealing chambers and their annular walls 16, 17,

18 can be designed in the manner shown in FIG. 2 or FIG. 3.

The introduction of the sealing liquid into the respective sealing chamber 7, 12 is solved differently.

The two sealing chambers 7, 12 are filled completely separately with sealing liquid as shown in FIG. 4. For this purpose, it is provided that a separate feed channel 11, 11′ opens into each of the two sealing chambers 7, 12. With the respective sealing chamber 7, 12, sealing liquid can be fed separately from an area outside the drum 2 through the respective feed channel 11, 11′ into the respective sealing chamber 7, 12.

In this way, various filling processes can be realized.

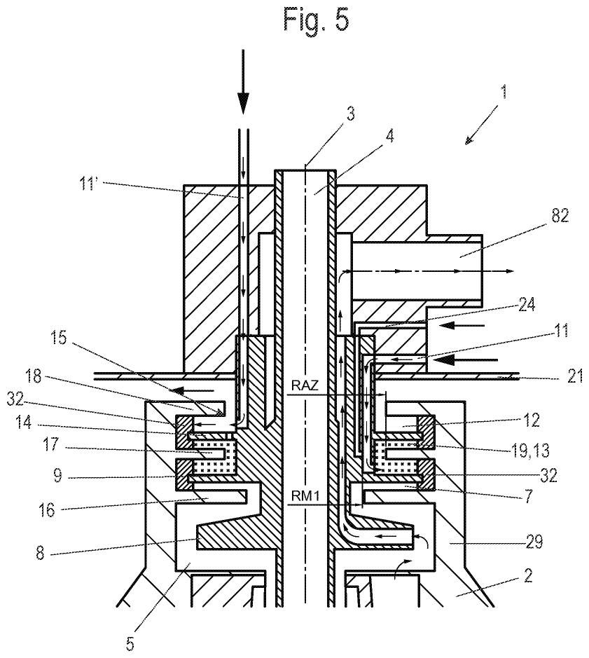

First, a first alternative as shown in FIG. 4 and then a second alternative as shown in FIG. 5 are described.

First of all, a centrifuge—in particular as shown in FIG. 1 with the drum head 29 as shown in FIG. 2—is provided in the method shown in FIG. 4. Then the drum 2 is set in rotation with a drive (not shown here).

Sealing liquid is then fed through the feed channels 11, 11′ into the two sealing chambers 7, 12 in such a way that the channels 11, 11′ are not immersed radially and in total in the sealing liquid in the respective sealing chamber 7, 12. According to this alternative, the sealing liquid is added without back pressure.

This is possible because the radius R_{M1} at the mouth of the respective feed channel 11, 11′ in the respective sealing chamber 7, 12 is smaller than the radius R_{AZ} of an outer edge of the intermediate wall 17.

The outlet of the feed channel 11′ into the upper sealing chamber 12 is preferably located above the (axially upper) sealing disk 14 in this upper sealing chamber 12.

The outlet of the feed channel 11 into the lower sealing chamber 7 is preferably located above the (axially lower) sealing disk 9 in the lower sealing chamber 12.

The volume of sealing liquid is preferably dosed by the control device in such a way that the sealing liquid does not overflow into the hood space.

A further annular space 19 can be formed around the intermediate annular wall 17 between the two sealing disks 9, 14 with suitable control and loading.

A further line 24 opens into this annular space, with which a fluid such as gas can be fed into the annular space 19 from a location outside the rotating system. This line 24 can also extend through the non-rotating shaft arrangement 41 or extend with it.

A further annular space 19 can be formed around the intermediate annular wall 17 between the two sealing disks 9, 14 with suitable control and loading. This annular space 19 forms a U-shaped section around the free end of the intermediate annular wall 17.

The annular space 19 is continuously flushed with an inert sealing gas 13 during operation of the centrifuge 1, so that any air or oxygen that may have penetrated from the space under the hood 21 through the sealing liquid in the second sealing chamber 12 can be flushed out. The escape of sealing gas 13, which leaves the annular space 19, can take place outside the hood 21. The sealing gas 13 is held in the annular space 19 by the two sealing disks 9, 14. The pressure in the annular space 19 can be set relatively freely by the control device; both overpressure and underpressure are possible.

The annular space 19 can also be filled with sealing gas 13 alone. In this case, the two sealing chambers 7, 12 are not filled with sealing liquid.

The inert sealing gas 13 is preferably CO₂. The sealing gas 13 can be fed from a gas reservoir (not shown here) via line 24 into the annular space 19. Furthermore, an outlet 25 can be provided for the sealing gas 13 from the annular space 19.

As CO₂ is heavier than air or oxygen, it is propelled outwards in the rotating annular space 19 during operation of the centrifuge 1. As a result, air or oxygen that has penetrated into the annular space 19 is displaced from the annular space 19. This creates an effective barrier against further penetration of air and thus also oxygen into the drum 2.

The sealing gas 13 can be fed into the annular space 19 by an actuator (not shown here), e.g., a valve, which can be controlled via the control unit so that the gas supply to the annular space 19 can be regulated.

FIG. 5 shows a detailed view of the drum head 29 of the drum 2 of the centrifuge 1 according to the second design, in which a supply of sealing liquid also takes place according to the first alternative.

The two sealing chambers 7, 12 are filled separately with sealing liquid. The channels 11, 11′ are not immersed in the sealing liquid in the respective sealing chamber 7, 12 and the sealing liquid is added without back pressure.

This is possible because the radius R_{M1} at the opening of the channels 11, 11′ into the respective sealing chamber 7, 12 is smaller than the radius R_{AZ} of an outer edge of the intermediate wall 17.

The volume of sealing liquid is dosed by the control device in such a way that the sealing liquid does not overflow into a space under the hood 21.

The annular space 19 between the two sealing disks 9, 14 is continuously flushed with an inert sealing gas 13 during operation of the centrifuge 1, so that any air or oxygen that may have penetrated from the space under the hood 21 through the sealing liquid in the second sealing chamber 12 can be flushed out. The escape of sealing gas 13, which leaves the annular space 19, can take place inside the hood 21. The sealing gas 13 is held in the annular space 19 by the two sealing disks 9, 14. The pressure in the annular space 19 can be set relatively freely by the control device; both overpressure and underpressure are possible.

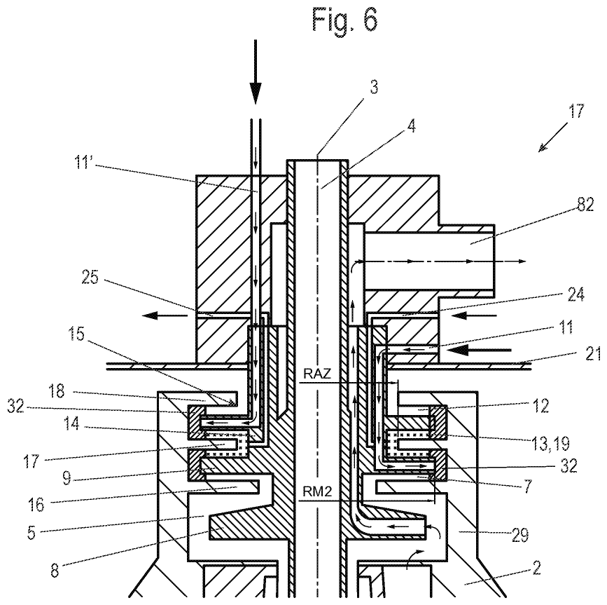

FIG. 6 shows a detailed view of the drum head 29 of the drum 2 of the centrifuge 1 according to the second design, in which a supply of sealing liquid takes place according to the second alternative.

The two sealing chambers 7, 12 are filled separately with sealing liquid. The channels 11, 11′ are immersed in the sealing liquid in the respective sealing chamber 7, 12 and the sealing liquid is added with a counter pressure.

This is possible because the radius R_{M2} at the opening of the channels 11, 11′ into the sealing chamber 7, 12 is larger than the radius R_{AZ} of the outer edge of the intermediate wall 17.

The volume of sealing liquid is dosed by the control device in such a way that the sealing liquid does not overflow into the space under the hood 21.

The annular space 19 between the two sealing disks 9, 14 is continuously flushed with an inert sealing gas 13 during operation of the centrifuge 1, so that any air or oxygen that may have penetrated from the space under the hood 21 through the sealing liquid in the second sealing chamber 12 can be flushed out. The escape of sealing gas 13, which leaves the annular space 19, can take place inside or outside the hood 21. The sealing gas 13 is held in position by the two sealing disks 9, 14. The pressure in the annular space 19 can be set relatively freely by the control device; both overpressure and underpressure are possible.

There is little or no mixing of the sealing gas 13 with the product flow in the gripper chamber 5 below the first sealing chamber 7. If it does, this has no negative influence on the product because CO₂ is also typically used in the beverage industry. As an alternative to CO₂, other gases that are heavier than air can also be used so that air, and therefore also the oxygen in the air, is displaced. Ideally, this should also be an inert gas such as argon.

Since gases, unlike liquids, are compressible, it can be assumed that the gas volume in the annular space 19 decreases as the rotational speed or speed of the drum 2 increases. Therefore, the supply 24 of the sealing gas 13 during operation of the drum 2 can take place as a function of the rotational speed or speed or alternatively be detected.

A gas sensor, in particular a CO₂ sensor, can also be provided on the line 24 and/or on the outlet 25 of the sealing gas 13, so that a kind of “level control” can be carried out by the control unit, which controls the actuator accordingly. It is also possible to fall back on empirical values, which are available in the form of a data record in the data memory of the control unit, for example. If the rotational speed is increased, more sealing gas 13 can be supplied accordingly. It is also possible to equip only a prototype of a centrifuge 1 according to the invention with the sensors in order to determine the necessary feed quantity at a suitable rotational speed. This can then be stored in a data memory of series products as a data record for the appropriate dimensioning of the supply quantity of sealing gas 13 as a function of the speed.

Undesirable oxygen absorption into the product is significantly reduced by the invention. The centrifuge 1 according to the invention is more robust than a centrifuge with a fully hermetic design, as there are no mechanical seals that are susceptible to wear. The requirement for sealing gas 13 is significantly lower compared to an inertization of the entire centrifuge or an inertization of a space above the sealing chambers 7, 12. The power requirement for the drive of the centrifuge 1 is also reduced, as the entire rotor no longer rotates in an inert gas atmosphere. The risk of CO₂ escaping and contaminating the space outside the centrifuge 1 is also reduced.

A separator or centrifuge 1 according to the invention is preferably suitable for all processing operations in which the exclusion of oxygen is advantageous in order to avoid undesirable oxidation processes.

This is the case when processing beverages, e.g., for fruit juices or beer. For example, vitamin C from citrus fruits or other fruit and vegetables reacts with oxygen. Other natural products are also oxidized, changing their color and taste. Another area of application is oxygen-sensitive reactions, which can occur in chemical synthesis, for example of pharmaceutical products. Typically, the application involves a variety of reactions under inert gas. Argon in particular can be used here instead of CO₂ due to its chemical inertness.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 Centrifuge
2 Drum
3 Axis of rotation
4 Feed pipe
41 Shaft arrangement
5 Gripper chamber
7 First sealing chamber
8 Gripper
81 Discharge channel
82 Discharge pipe
9 First sealing disk
11, 11′ Feed channel
12 Second sealing chamber
13 Sealing gas
14 Second sealing disk
15 Overflow edge
16 Lower annular wall
17 Intermediate annular wall
18 Upper annular wall
19 Annular space
20 Discharge nozzle
21 Hood
22 Piston slide
23 Distributor space
24 Line
25 Outlet
26 Separation space
27 Separating plate stack
29 Drum head
30 Spindle
31 Reservoir
32 Sealing medium
P Suspension
L Liquid phase
S Solid phase
R_{M1} Radius
R_{M2} Radius
R_{AZ} Radius

1-20. (canceled)

21. A centrifuge configured to separate or clarify a flowable product or a flowable suspension into at least two phases in a centrifugal field in continuous operation, wherein the centrifuge comprises:
a rotatably mounted drum drivable by a drive motor to rotate about a vertical axis of rotation; and
a drum shell made of metal,
wherein the rotatably mounted drum comprises
a feed pipe and at least one gripper chamber with a gripper configured to discharge separated or clarified liquid; and
at least two axially superimposed sealing chambers arranged above the gripper chamber, wherein each of the at least two axially superimposed sealing chambers has a sealing disk projecting into the respective one of the at least two axially superimposed sealing chambers,
wherein the rotatably mounted drum further comprises
at least one feed channel configured to feed a sealing medium into one of the at least two axially superimposed sealing chambers, or
at least one feed channel configured to feed the sealing medium into the respective one of the at least two axially superimposed sealing chambers sealing chambers.

22. The centrifuge of claim 21, further comprising a line configured to
feed a gas into an annular space around an annular intermediate wall extending radially inwards from the drum shell between the at least two axially superimposed two sealing chambers, or
evacuate a gas from the annular space.

23. The centrifuge of claim 22, further comprising:
an outlet configured to discharge the gas from the annular space.

24. The centrifuge of claim 22, wherein the gas is a sealing gas, which is heavier than air.

25. The centrifuge of claim 21, wherein the at least two axially superimposed sealing chambers sealing chambers comprise:
a first sealing chamber delimited radially downwards from the gripper chamber by an annular wall extending radially inwards from the drum shell in a region of the drum head and perpendicularly to the axis of rotation and ends radially spaced from an inner shaft arrangement, which does not rotate with the rotatably mounted drum during operation but extends axially into the rotatably mounted drum.

26. The centrifuge of claim 22, wherein the at least two axially superimposed sealing chambers comprise:
a first sealing chamber; and
a second sealing chamber,
wherein the second sealing chamber is arranged above the first sealing chamber,
wherein the first sealing chamber is axially delimited by the annular intermediate wall from the second sealing chamber, which extends radially inwards from the drum shell in the region of the drum head perpendicular to the axis of rotation and ends radially spaced from an inner shaft arrangement, which does not rotate with the rotatably mounted drum during operation but extends axially into the rotatably mounted drum.

27. The centrifuge of claim 25, wherein the at least two axially superimposed sealing chambers sealing chambers further comprise:
a second sealing chamber having an annular wall and a radially inner overflow edge arranged at and delimiting a top of the annual wall, wherein the radially inner overflow edge extends radially and perpendicularly to the axis of rotation inwards from the drum shell in the region of the drum head and ends radially spaced from an inner shaft arrangement, which does not rotate with the drum during operation but extends axially into the drum.

28. The centrifuge of claim 22, wherein a radius at a mouth of the at least one feed channel in one of the at least two axially superimposed sealing chambers is smaller than a radius of a radial inner edge of the intermediate wall.

29. The centrifuge of claim 22, wherein a radius at a mouth of the at least one feed channel in one of the at least two axially superimposed sealing chambers is greater than a radius of an inner edge of the intermediate wall.

30. The centrifuge of claim 23, further comprising:
a gas sensor arranged on the line or on the outlet.

31. The centrifuge of claim 22, wherein the sealing medium flows from a reservoir located outside the centrifuge into the at least one feed channel.

32. The centrifuge of claim 22, wherein the sealing gas flows from a gas reservoir via the line into the annular space.

33. A method, comprising:
providing a centrifuge configured to separate or clarify a flowable product or a flowable suspension into at least two phases in a centrifugal field in continuous operation, wherein the centrifuge comprises:
a rotatably mounted drum drivable by a drive motor to rotate about a vertical axis of rotation; and
a drum shell made of metal,
wherein the rotatably mounted drum comprises
a feed pipe and at least one gripper chamber with a gripper configured to discharge separated or clarified liquid; and
at least two axially superimposed sealing chambers arranged above the gripper chamber, wherein each of the at least two axially superimposed sealing chambers has a sealing disk projecting into the respective one of the at least two axially superimposed sealing chambers,
wherein the rotatably mounted drum further comprises
at least one feed channel configured to feed a sealing medium into one of the at least two axially superimposed sealing chambers, or
at least one feed channel configured to feed the sealing medium into the respective one of the at least two axially superimposed sealing chambers sealing chambers;
supplying the flowable product or flowable suspension to the feed pipe to separate or clarify the flowable product into at least two phases;
filling one of the at least two axially superimposed sealing chambers with sealing liquid via the feed channel leading into the at least two axially superimposed sealing chambers without additional counterpressure, so that an outlet opening from the at least one feed channel is not immersed in the sealing liquid in the respective one of the at least two axially superimposed sealing chambers until the sealing disk in the respective one of the at least two axially superimposed sealing chambers is immersed in the sealing liquid and overflows into the other one of the at least two axially superimposed sealing chambers, and continue filling until the other one of the at least two axially superimposed sealing chambers fills so that the sealing disk of the other one of the at least two axially superimposed sealing chambers is immersed in the sealing liquid.

34. A method, comprising:
providing a centrifuge configured to separate or clarify a flowable product or a flowable suspension into at least two phases in a centrifugal field in continuous operation, wherein the centrifuge comprises:
a rotatably mounted drum drivable by a drive motor to rotate about a vertical axis of rotation; and
a drum shell made of metal,
wherein the rotatably mounted drum comprises
a feed pipe and at least one gripper chamber with a gripper configured to discharge separated or clarified liquid; and
at least two axially superimposed sealing chambers arranged above the gripper chamber, wherein each of the at least two axially superimposed sealing chambers has a sealing disk projecting into the respective one of the at least two axially superimposed sealing chambers,
wherein the rotatably mounted drum further comprises
at least one feed channel configured to feed a sealing medium into one of the at least two axially superimposed sealing chambers, or
at least one feed channel configured to feed the sealing medium into the respective one of the at least two axially superimposed sealing chambers sealing chambers;
supplying the flowable product or flowable suspension to the feed pipe to separate or clarify the flowable product into at least two phases; and
filling the at least two axially superimposed sealing chambers with a supply pressure until the sealing disks of the at least two axially superimposed sealing chambers are immersed in the sealing liquid.

35. The method of claim 34, further comprising:
pressurizing an annular space, which is axially limited by the at least two axially superimposed sealing disks and in which an intermediate annular wall is located, with a sealing gas, during centrifugal operation of the centrifuge; or
evacuating the annular space during centrifugal operation of the centrifuge.

36. The method of claim 35, wherein the sealing gas is an inert gas.

37. The method of claim 36, wherein the sealing gas is fed into the annular space through a line and is discharged from the annular space through a discharge line.

38. The method of claim 35, wherein the sealing gas is supplied as a function of a rotational speed of the rotatably mounted drum.

39. The method of claim 35, wherein a supply of sealing gas in the annular space and a discharge of sealing gas from the annular space during operation of the centrifuge are performed as a function of a filling level of the annular space.
